(19) United States
(12) Patent Application Publication
(10) Pub. No.: US 2026/0171338 A1
(43) Pub. Date: Jun. 18, 2026

(54) ELECTROMAGNETIC RELAY

(71) Applicant: SONG CHUAN PRECISION CO., LTD., NEW TAIPEI CITY (TW)

(72) Inventor: SUNG-JEN WU, NEW TAIPEI CITY (TW)

(21) Appl. No.: 18/979,657

(22) Filed: Dec. 13, 2024

(51) Int. Cl. H01H 50/14; H01H 50/02; H01H 50/18; H01H 50/54

(52) U.S. Cl. CPC H01H 50/14; H01H 50/02; H01H 50/54; H01H 50/18

(57) ABSTRACT

An electromagnetic relay includes a casing, an electromagnet installed in the casing, a movable armature installed in the casing and disposed on a side of the electromagnet, a movable contact module installed in the casing, connected to the movable armature, and having first and second contact plates, and a fixed contact module partially disposed inside and outside the casing. The first contact plate has first and second movable contacts, the second contact plate has third and fourth movable contacts. The fixed contact module has first to fourth terminal plates, and the parts of the first to fourth terminal plates disposed in the casing having first to fourth fixed contacts. The movable contact module is driven by the movable armature through an electromagnetic effect of the electromagnet to define whether the first to fourth movable contacts and the corresponding first to fourth fixed contacts are in contact or non-contact status, respectively.

### BACKGROUND OF THE DISCLOSURE

### Technical Field

The present disclosure relates to the field of relays, and more particularly relates to an electromagnetic relay with the structural design of terminal pins that form a parallel current path during conduction to withstand large current.

### Description of the Related Art

Electromagnetic relay is a key component for circuit control using the principle of electromagnetism, which is mostly used in industrial automation, power systems, communication equipment, and other fields. The electromagnetic relay has high isolation, high stability and multi-channel control capability, especially in large current environments where frequent switching is required, and it effectively copes with high current loads and ensures that the contacts will not fail due to overheating or melting. The design characteristics of the electromagnetic relay make it a core component in power load switching, circuit protection and stable system operation. In addition, it also has the characteristics of simple structure, low cost and strong anti-interference, so it plays an important role in many application areas, such as low-frequency switching control, power load switching, etc.

Although the technology of electromagnetic relays has been matured and widely used, there is still room for further improvement in the related art to enhance the performance and adaptability of the electromagnetic relays to meet higher technological demands and application environments, for example, with the development of various types of electronic products, new energy system applications, etc., the electromagnetic relay also needs to have a higher level of endurance, and the ability of carrying higher power or larger current load.

In view of the above, the discloser of the present disclosure based on years of experience and professional knowledge in the related industry to provide a novel technical solutions for the electromagnetic relays.

### SUMMARY OF THE DISCLOSURE

It is a primary objective of the present disclosure to provide an electromagnetic relay with a design of stagging fixed terminals to form a parallel path to reduce contact resistance and provide good heat dissipation capability, so as to effectively enhance the strength of the electromagnetic relay to withstand large current.

To achieve the aforementioned objective, the present disclosure discloses an electromagnetic relay, including a casing; an electromagnet, installed in the casing; a movable armature, installed the casing and disposed on a side of the electromagnet; a movable contact module, installed in the casing and connected to the movable armature, the movable contact module having a first contact plate and a second contact plate, the first contact plate having a first movable contact and a second movable contact, the second contact plate having a third movable contact and a fourth movable contact; and a fixed contact module, partially disposed inside the casing, partially disposed outside the casing, the fixed contact module having a first terminal plate, a second terminal plate, a third terminal plate and a fourth terminal plate which are not contacted with each other, the part of the first terminal plate disposed inside the casing having a first fixed contact, the part of the second terminal plate disposed inside the casing having a second fixed contact, the part of the third terminal plate disposed inside the casing having a third fixed contact, and the part of the fourth terminal plate partially disposed inside the casing having a fourth fixed contact; wherein, the parts of the first terminal plate and the second terminal plate disposed outside the casing are configured corresponding to the first contact plate, the third terminal plate and the fourth terminal plate disposed outside the casing are configured corresponding to the second contact plate; the first fixed contact disposed inside the casing is configured corresponding to the first movable contact, the fourth fixed contact is configured corresponding to the fourth movable contact, and the third fixed contact is configured corresponding to the second movable contact, the second fixed contact is configured corresponding to the third movable contact, to form a configuration that the second terminal plate and the third terminal plate are staggered with each other in the casing; the movable contact module is driven by the movable armature through an electromagnetic effect of the electromagnet to define whether the first movable contact, the second movable contact, the third movable contact and the fourth movable contact and the corresponding first fixed contact, the corresponding third fixed contact, the corresponding second fixed contact and the corresponding fourth fixed contact are in a contact or non-contact status, respectively.

Preferably, the parts of the first terminal plate, the second terminal plate, the third terminal plate and the fourth terminal plate disposed outside the casing are arranged in the configuration of two rows and two columns.

Preferably, the casing further contains a first insulation part and a second insulation part disposed, a side of the first insulation part is provided with a first accommodation slot for accommodating a part of the third terminal plate, and the other side of the first insulation part is provided for abutting against the first terminal plate; a side of the second insulation part is provided with a second accommodation slot for accommodate a part of the second terminal plate, and the other side of the second insulation part is provided is provided for abutting against the fourth terminal plate, so that the first terminal plate, the second terminal plate, the third terminal plate and the fourth terminal plate are insulated from each other.

Preferably, the first insulation part comprises a first baffle plate, a second baffle plate, a third baffle plate, a fourth baffle plate and a fifth baffle plate; the first baffle plate is parallel to the second baffle plate, the area of the first baffle plate is greater than the second baffle plate, the third baffle plate is L-shaped and perpendicularly coupled to the first baffle plate and the second baffle plate respectively, the fourth baffle plate comprises a first bent section and a side of the fourth baffle plate is coupled to the third baffle plate and the second baffle plate respectively, the fifth baffle plate comprises a second bent section, and a side of the fifth baffle plate is coupled to the first baffle plate, the second baffle plate, the third baffle plate respectively, so that the space enclosed by the first baffle plate, the second baffle plate, the third baffle plate, the fourth baffle plate and the fifth baffle plate forms the first accommodation slot.

Preferably, the second insulation part comprises two parallel sixth baffle plates and a seven baffle plate, the seven baffle plate comprises a third bent section, the sixth baffle plates separately comprise a stepped sheet with a height difference and a large-area surface and a small-area surface, the seven baffle plate is disposed between the sixth baffle plates, and extends from an end of the large-area surface adjacent to the small-area surface to the diagonally opposite end of the large-area surface, the small-area surface forms a slot, and a part of the fourth terminal plate is disposed in the slot.

Preferably, the bottom of second insulation part is provided with a limiting part for abutting and fixing with a mount surface of a working circuit.

Preferably, the end positions of the first terminal plate, the second terminal plate, the third terminal plate and the fourth terminal plate disposed outside the casing have at least one open slot.

Preferably, the parts of the first terminal plate, the second terminal plate, the third terminal plate and the fourth terminal plate outside the casing are arranged in the configuration of one row and four columns.

Preferably, the casing further includes a third insulation part disposed between the second terminal plate and the third terminal plate, so that the second terminal plate and the third terminal plate are insulated from each other.

Preferably, the third insulation part includes a first mount part and a second mount part, the first mount part and the second mount part are relatively isolated area; the first mount part comprises a first accommodation section and a second accommodation section, the second accommodation section is a downward extension area relative to the first accommodation section; the second mount part is disposed under the first accommodation section of the first mount part to form a channel, so that the first mount part is used to accommodate the third terminal plate, and a partial area of the second terminal plate is disposed on the second mount part.

In summation of the description above, the electromagnetic relay of the present disclosure is based on the design of the fixed terminal and utilizes the structure of two contact plates and four terminal plates to achieve the goal of forming two parallel paths to reduce the contact resistance and thus enhancing the strength of the electromagnetic relay to withstand large current during conduction. Further, the present disclosure also sets forth numerous implementation examples, the detailed technical characteristics of which are as described in each paragraph above.

### BRIEF DESCRIPTION OF THE DRAWINGS

FIG. 1 is an exploded view of an electromagnetic relay in accordance with a first embodiment of the present disclosure;

FIG. 2 is a schematic assembly view of the electromagnetic relay in accordance with the first embodiment of the present disclosure;

FIG. 3A is a schematic structural view of a first insulation part of the electromagnetic relay in accordance with the first embodiment of the present disclosure;

FIG. 3B is another schematic structural view of the first insulation part of the electromagnetic relay in accordance with the first embodiment of the present disclosure;

FIG. 4A is a schematic structural view of a second insulation part of the electromagnetic relay in accordance with the first embodiment of the present disclosure;

FIG. 4B is another schematic structural view of the second insulation part of the electromagnetic relay in accordance with the first embodiment of the present disclosure;

FIG. 5 is a schematic assembly view of an electromagnetic relay in accordance with another implementation mode of the first embodiment of the present disclosure;

FIG. 6 is an exploded view of an electromagnetic relay in accordance with a second embodiment of the present disclosure;

FIG. 7 is a schematic structural view of a third insulation part of the electromagnetic relay in accordance with the second embodiment of the present disclosure;

FIG. 8 is a schematic assembly view of the electromagnetic relay in accordance with the second embodiment of the present disclosure; and

FIG. 9 is a schematic plan view of the electromagnetic relay in accordance with the second embodiment of the present disclosure.

### DETAILED DESCRIPTION OF THE PREFERRED EMBODIMENTS

To make it easier for the examiner to understand the content of the present disclosure, the specification accompanied by the drawings is described as follows.

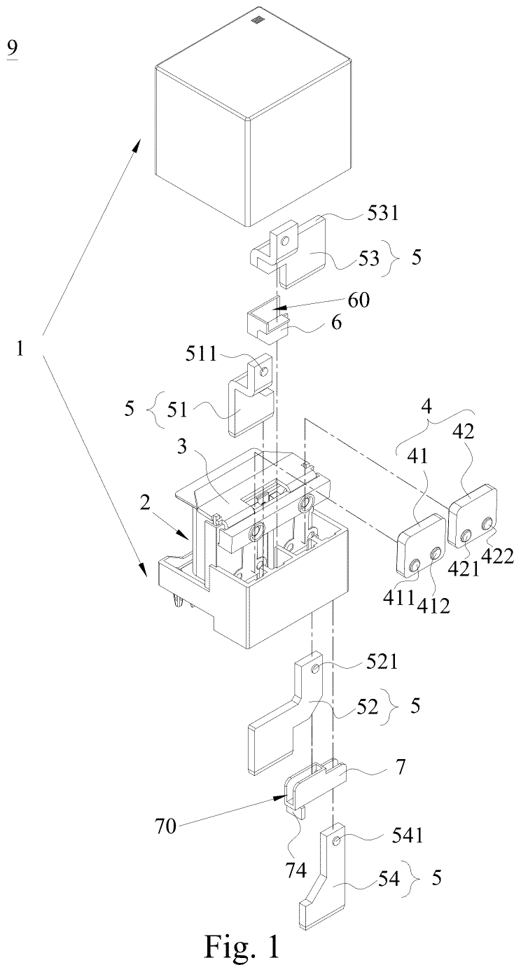

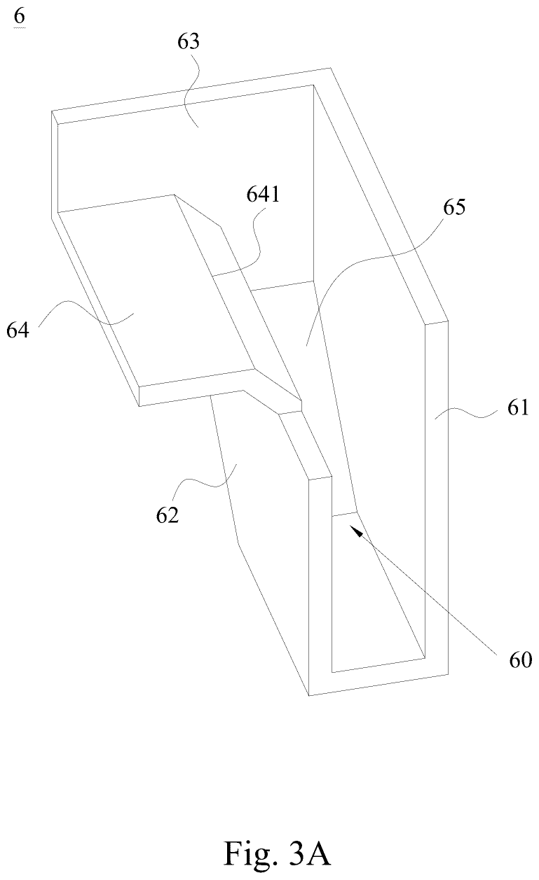

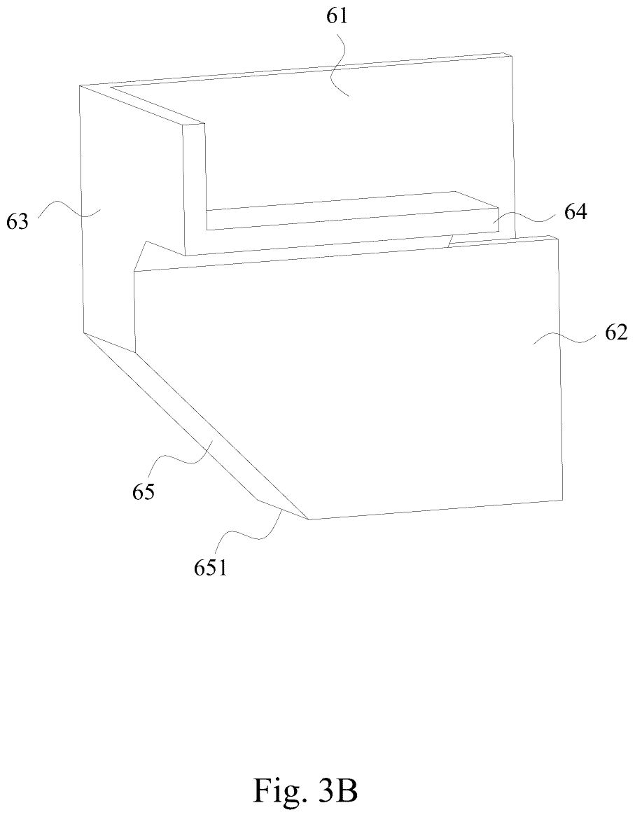

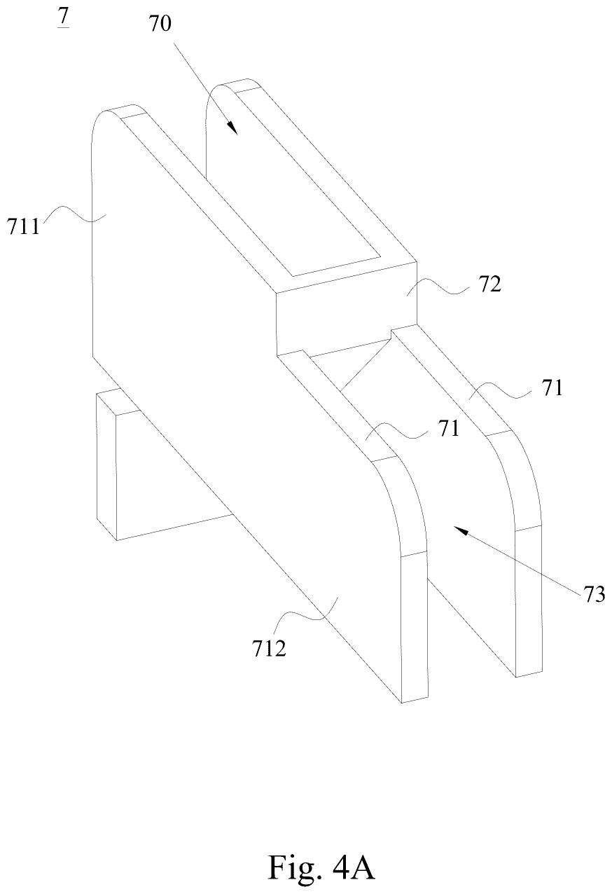

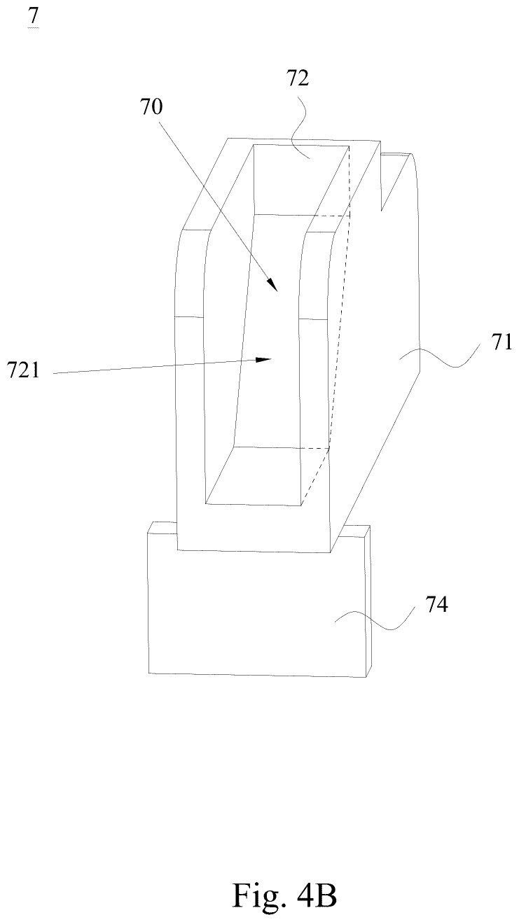

With reference to FIGS. 1 to 4B for the exploded view of an electromagnetic relay, the schematic assembly view of the electromagnetic relay, the two schematic structural views of a first insulation part and the two schematic structural views of a second insulation part in accordance with the first embodiment of the present disclosure respectively, the electromagnetic relay 9 of the present disclosure includes a casing 1, an electromagnet 2, a movable armature 3, a movable contact module 4 and a fixed contact module 5.

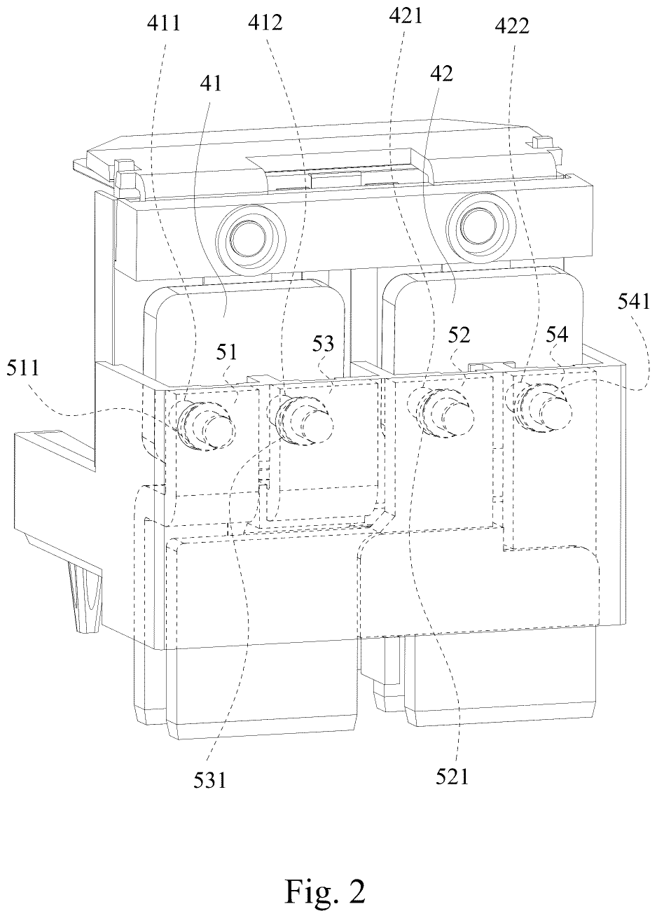

The casing 1 can be a structure with an upper cover and a base detachably engaged with each other. For the convenience of illustration, the upper cover and the base of the casing 1 are shown in a separate state in FIG. 1, and the upper cover is omitted in FIG. 2. The electromagnet 2 is installed in the casing 1, and the movable armature 3 is installed in the casing 1 and disposed on a side of the electromagnet 2. The movable contact module 4 is installed in the casing 1 and connected to the movable armature 3, the movable contact module 4 includes a first contact plate 41 and a second contact plate 42, the first contact plate 41 has a first movable contact 411 and a second movable contact 412, and the second contact plate 42 has a third movable contact 421 and a fourth movable contact 422. A part of the fixed contact module 5 is disposed inside the casing 1, a part of the fixed contact module 5 is disposed outside the casing 1, the fixed contact module 5 includes a first terminal plate 51, a second terminal plate 52, a third terminal plate 53 and a fourth terminal plate 54 which are not contacted with each other, the part of the first terminal plate 51 disposed inside the casing 1 has a first fixed contact 511, the part of the second terminal plate 52 disposed inside the casing 1 has a second fixed contact 522, the part of the third terminal plate 53 disposed inside the casing 1 has a third fixed contact 531, and the part of the fourth terminal plate 54 disposed inside the casing 1 has a fourth fixed contact 541. Wherein, the parts of the first terminal plate 51 and the second terminal plate 52 disposed outside the casing 1 is configured corresponding to the first contact plate 41, the parts of the third terminal plate 53 and the fourth terminal plate 54 disposed outside the casing 1 is configured corresponding to the second contact plate 42. In the casing 1, the first fixed contact 511 is configured corresponding to the first movable contact 411, the fourth fixed contact 541 is configured corresponding to the fourth movable contact 422, the third fixed contact 531 is configured corresponding to the second movable contact 412, the second fixed contact 521 is configured corresponding to the third movable contact 421 to form a configuration that the second terminal plate 52 and the third terminal plate 53 are staggered with each other in the casing 1. The movable contact module 4 under the electromagnetic effect of the electromagnet 2 is driven by the movable armature 3 to define whether the first movable contact 411, the second movable contact 412, the third movable contact 421 and the fourth movable contact 422 and the corresponding first fixed contact 511, the corresponding third fixed contact 531, the corresponding second fixed contact 521 and the corresponding fourth fixed contact 541 are in a contact or non-contact status, respectively. In FIG. 1, only the first fixed contact 511, the third fixed contact 531, the second fixed contact 521 and the fourth fixed contact 541 are shown and labeled on a side of the first terminal plate 51, the second terminal plate 52, the third terminal plate 53 and the fourth terminal plate 54, but actually the first fixed contact 511, the third fixed contact 531, the second fixed contact 521 and the fourth fixed contact 541 pass through the first terminal plate 51, the second terminal plate 52, the third terminal plate 53 and the fourth terminal plate 54 respectively to facilitate the first movable contact 411, the second movable contact 412, the third movable contact 421 and the fourth movable contact 422 to form the contact or non-contact state.

Through the above structural features, it is possible to form a parallel current circuit in the application, which can effectively reduce resistance and avoid overheating, so that the electromagnetic relay is suitable for applications carrying high currents, and can simplify the problem of setting up the subsequent electrical circuit, and simultaneously improve the applications.

In practice, the first terminal plate 51 and the second terminal plate 52 are inputted or outputted from the same source, the third terminal plate 53 and the fourth terminal plate 54 are outputted or inputted from the same source and can be used in the plurality of working circuits. The third terminal plate 53 and the fourth terminal plate 54 will be the same source output or input, so that they are applicable to the plurality of working circuits. In addition, through the above structural features, each of the parallel circuits will have two terminal plates as input and output terminals respectively to provide better heat dissipation and easiness to comply with the relevant safety regulations.

In this embodiment, the parts of the first terminal plate 51, the second terminal plate 52, the third terminal plate 53 and the fourth terminal plate 54 disposed outside the casing 1 are arranged into the configuration of two rows and two columns, as shown in FIG. 2, to facilitate reducing the volume of the relay. In addition, to increase the certainty of isolation between the terminal plates, the casing 1 further includes a first insulation part 6 and a second insulation part 7 installed in the casing 1, a side of the first insulation part 6 is provided with a first accommodation slot 60 for accommodating a part of the third terminal plate 53, the other side of the first insulation part 6 is provided for abutting with the first terminal plate 51; a side of the second insulation part 7 is provided with a second accommodation slot 70 for accommodating a part of the second terminal plate 52, and the other side of the second insulation part 7 is provided for abutting the fourth terminal plate 54, so that the first terminal plate 51, the second terminal plate 52, the third terminal plate 53 and the fourth terminal plate 54 are insulated from each other. With the installation of the first insulation part 6 and the second insulation part 7, the positioning effect can also be achieved to improve the convenience of assembling each terminal plate, for example, the first insulation part 6 and the second insulation part 7 can be used as positioning parts during the assembly of each terminal plate. Preferably, the first insulation part 6 and the second insulation part 7 are made of plastic to provide good insulation effect.

In order to achieve the above-mentioned structural assembly of the first insulation part 6 and the first terminal plate 51 and the third terminal plate 53, the following preferred embodiment is provided. The first insulation part 6 includes a first baffle plate 61, a second baffle plate 62, a third baffle plate 63, a fourth baffle plate 64 and a fifth baffle plate 65; wherein the first baffle plate 61 is parallel to the second baffle plate 62, and the area of the first baffle plate 61 is greater than the second baffle plate 62, the third baffle plate 63 is L-shaped and perpendicularly connected to the first baffle plate 61 and the second baffle plate 62, the fourth baffle plate 64 has a first bent section 641 and a side of the fourth baffle plate 64 is connected to the third baffle plate 63 and the second baffle plate 62, the fifth baffle plate 65 has a second bent section 651, and a side of the fifth baffle plate 65 is connected to the first baffle plate 61, the second baffle plate 62, the third baffle plate 63, so that the space enclosed by the first baffle plate 61, the second baffle plate 62, the third baffle plate 63, the fourth baffle plate 64 and the fifth baffle plate 65 forms the first accommodation slot 60.

In order to achieve the above-mentioned structural assembly of the second insulation part 7 and the second terminal plate 52 and the fourth terminal plate 54, the following embodiment is provided. The second insulation part 7 has two parallel sixth baffle plates 71 and one seven baffle plate 72, the seven baffle plate 72 has a third bent section 721, the sixth baffle plates 71 have a stepped sheet with a height difference and a large-area surface 711 and a small-area surface 712, the seven baffle plate 72 is installed between the sixth baffle plates 71 and extends from the end of the large-area surface 711 adjacent to the small-area surface 712 to the diagonally opposite end of the large-area surface 711, the small-area surfaces 712 form a slot 73, and a part of the fourth terminal plate 54 is disposed in the slot 73.

In order to improve the convenience and positioning accuracy when the electromagnetic relay 9 is assembled with an external working circuit, the second insulation part 7 has a limiting part 74 disposed on the bottom and provided for abutting and fixing a mount surface of a working circuit (not shown in the figure).

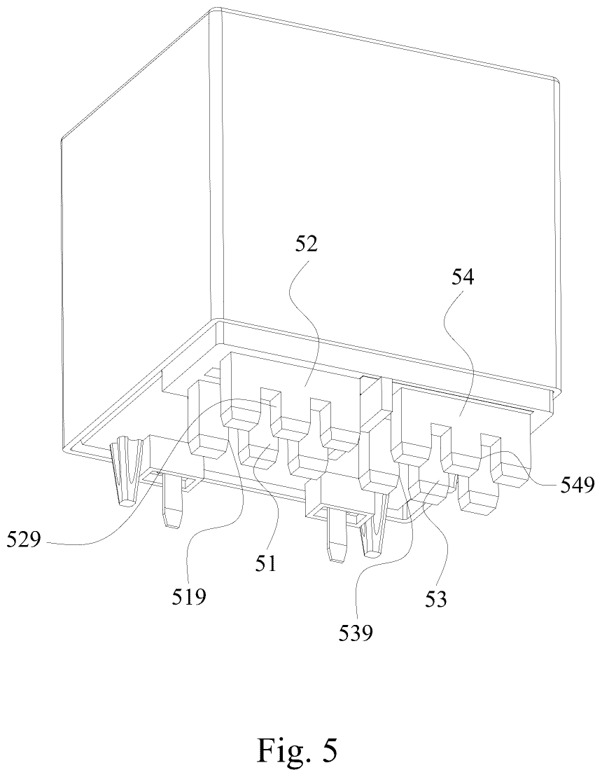

With reference to FIG. 5 for the schematic assembly view of the electromagnetic relay in accordance with another implementation mode of the first embodiment of the present disclosure, the end positions of the first terminal plate 51, the second terminal plate 52, the third terminal plate 53 and the fourth terminal plate 54 disposed outside the casing 1 are provided with at least one open slot 519, 529, 539, 549 for improving the stability when assembled with external circuits.

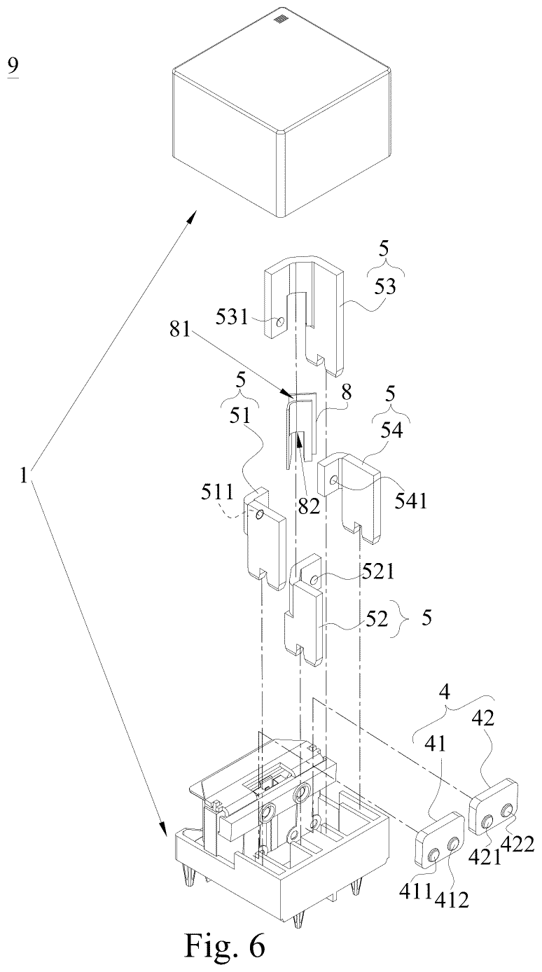

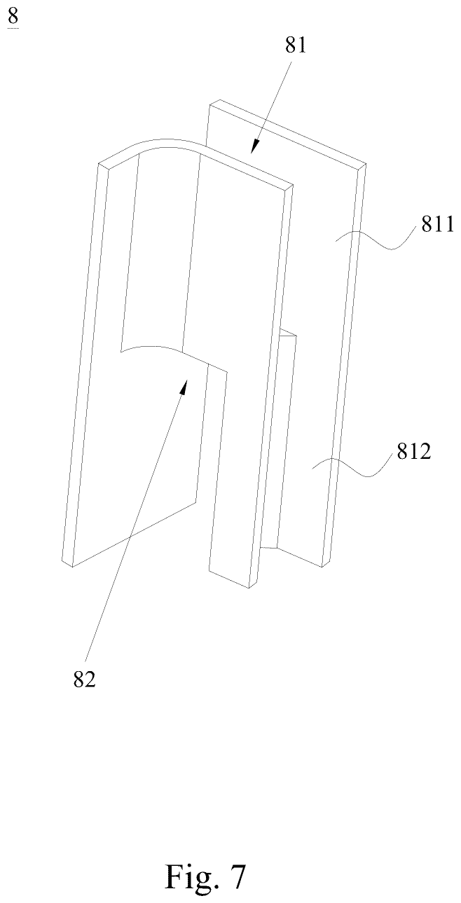

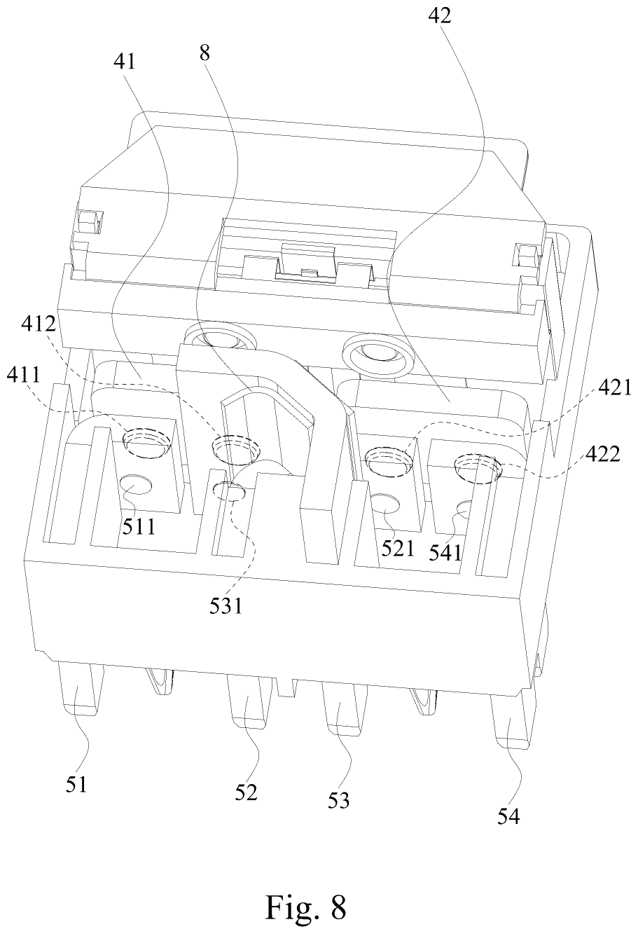

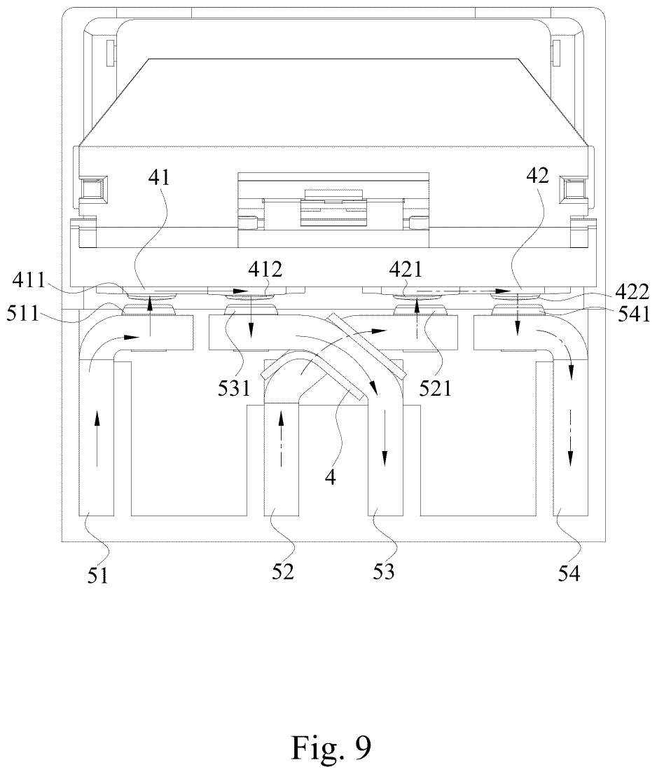

With reference to FIGS. 6 to 9 for the exploded view of an electromagnetic relay, the schematic view of a third insulation part, the schematic assembly view of an electromagnetic relay and the schematic plan view of the electromagnetic relay in accordance with the second preferred embodiment of the present disclosure respectively, the parts of the first terminal plate 51, the second terminal plate 52, the third terminal plate 52 and the fourth terminal plate 54 disposed outside the casing 1 are arranged into the configuration of one row and four columns. In FIGS. 6 and 8, only the first fixed contact 511, the third fixed contact 531, the second fixed contact 521 and the fourth fixed contact 541 are shown and labelled on a side of the first terminal plate 51, the second terminal plate 52, the third terminal plate 53 and the fourth terminal plate 54, but actually the first fixed contact 511, the third fixed contact 531, the second fixed contact 521 and the fourth fixed contact 541 are passed through the first terminal plate 51, the second terminal plate 52, the third terminal plate 53 and the fourth terminal plate 54 to facilitate the first movable contact 411, the second movable contact 412, the third movable contact 421 and the fourth movable contact 422 to define the contact or non-contact state. In FIG. 9, the arrow sign is provided to indicate the current direction of the first fixed contact 511, the third fixed contact 531, the second fixed contact 521 and the fourth fixed contact 541 and the first movable contact 411, the second movable contact 412, the third movable contact 421 and the fourth movable contact 422 after conduction.

Further, the casing 1 includes a third insulation part 8 installed between the second terminal plate 52 and the third terminal plate 53, so that the second terminal plate 52 and the third terminal plate 53 are insulated from each other, to facilitate increasing the certainty of isolation of the staggered second terminal plate 52 and third terminal plate 53, while achieving the positioning purpose of each terminal plate during assembly. Similarly, the third insulation part 8 can be made of plastic. Specifically, in a preferred embodiment of the third insulation part 8, the third insulation part 8 has a first mount part 81 and a second mount part 82, and the first mount part 81 and the second mount part 82 are opposite isolation areas; wherein the first mount part 81 has a first accommodation section 811 and a second accommodation section 812, the second accommodation section 812 is a downward extension area relative to the first accommodation section 811; the second mount part 82 is disposed under the first accommodation section 811 of the first mount part 81 to form a channel, so that the first mount part 81 is used for accommodating the third terminal plate 53, and a partial area of the second terminal plate 52 is disposed at the second mount part 82.

In summation of the description above, the electromagnetic relay of the present disclosure is based on the design of the fixed terminal and utilizes the structure of two contact plates and four terminal plates to achieve the goal of forming two parallel paths to reduce the contact resistance and thus enhancing the strength of the electromagnetic relay to withstand large current during conduction. In other words, the fixed terminal design used for connecting to the external working circuit effectively reduces the probability of operation which is incompliant with safety regulations and the difficulty of assembly. At the same time, the present disclosure also provides the feature of staggering the third and second terminal plates, so that when the first to fourth terminal plates are connected to the external circuit, the input ends are on the same side and the output ends are also on the same side, so that it is applicable for the input and output design based on existing external circuit conditions. Further, the present disclosure also proposes specific structural embodiments of the electromagnetic relay, such as arranging the part of the terminal plate outside the casing into the configuration of two rows and two columns or one row and four columns. In order to improve the reliability of isolating each terminal plate, the casing can be equipped with a first insulation part and a second insulation part, as shown in the structure of the first embodiment; or the casing can be equipped with a third insulation part as shown in the structure of the second embodiment, and the present disclosure also provides a more specific description of the structural features of the first second, and third insulation parts. In addition, the stability of the connection with the external working circuit can be improved and achieved by the limiting part on the bottom of the second insulation part or the open slot at the end of the terminal plate.

What is claimed is:

1. An electromagnetic relay, comprising:
a casing;
an electromagnet, installed in the casing;
a movable armature, installed in the casing and disposed on a side of the electromagnet;
a movable contact module, installed in the casing and coupled to the movable armature, the movable contact module having a first contact plate and a second contact plate, the first contact plate having a first movable contact and a second movable contact, and the second contact plate having a third movable contact and a fourth movable contact; and
a fixed contact module, partially disposed inside the casing, and partially disposed outside the casing, the fixed contact module having a first terminal plate, a second terminal plate, a third terminal plate, and a fourth terminal plate, which are not contacted with each other, a portion of the first terminal plate disposed inside the casing having a first fixed contact, a portion of the second terminal plate disposed inside the casing having a second fixed contact, a portion of the third terminal plate disposed inside the casing having a third fixed contact, and a portion of the fourth terminal plate disposed inside the casing having a fourth fixed contact,
wherein portions of the first terminal plate and the second terminal plate disposed outside the casing correspond to the first contact plate, portions of the third terminal plate and the fourth terminal plate disposed outside the casing correspond to the second contact plate,
the first fixed contact disposed inside the casing corresponds to the first movable contact, the fourth fixed contact corresponds to the fourth movable contact, and the third fixed contact corresponds to the second movable contact, the second fixed contact corresponds to the third movable contact, to form a configuration that the second terminal plate and the third terminal plate are staggered with each other in the casing, and
the movable contact module is driven by the movable armature through an electromagnetic effect of the electromagnet to define whether the first movable contact, the second movable contact, the third movable contact, and the fourth movable contact and the corresponding first fixed contact, the corresponding third fixed contact, the corresponding second fixed contact and the corresponding fourth fixed contact are in a contact or non-contact status, respectively.

2. The electromagnetic relay according to claim 1, wherein end positions of the first terminal plate, the second terminal plate, the third terminal plate, and the fourth terminal plate disposed outside the casing are provided with at least one open slot.

3. The electromagnetic relay according to claim 1, wherein the portions of the first terminal plate, the second terminal plate, the third terminal plate, and the fourth terminal plate disposed outside the casing are arranged in a configuration of two rows and two columns.

4. The electromagnetic relay according to claim 3, wherein end positions of the first terminal plate, the second terminal plate, the third terminal plate, and the fourth terminal plate disposed outside the casing are provided with at least one open slot.

5. The electromagnetic relay according to claim 3, wherein the casing comprises a first insulation part and a second insulation part disposed therein, a side of the first insulation part is provided with a first accommodation slot for accommodating a part of the third terminal plate, and another side of the first insulation part is provided for abutting against the first terminal plate, a side of the second insulation part is provided with a second accommodation slot for accommodate a part of the second terminal plate, and another side of the second insulation part is provided is provided for abutting against the fourth terminal plate, so that the first terminal plate, the second terminal plate, the third terminal plate, and the fourth terminal plate are insulated from each other.

6. The electromagnetic relay according to claim 5, wherein end positions of the first terminal plate, the second terminal plate, the third terminal plate, and the fourth terminal plate disposed outside the casing are provided with at least one open slot.

7. The electromagnetic relay according to claim 5, wherein the first insulation part comprises a first baffle plate, a second baffle plate, a third baffle plate, a fourth baffle plate, and a fifth baffle plate,
the first baffle plate is parallel to the second baffle plate, and an area of the first baffle plate is greater than an area of the second baffle plate,
the third baffle plate has a L-shape and perpendicularly coupled to the first baffle plate and the second baffle plate, respectively, and
the fourth baffle plate comprises a first bent section and sides of the fourth baffle plate are coupled to the third baffle plate and the second baffle plate, respectively, the fifth baffle plate comprises a second bent section, and sides of the fifth baffle plate are coupled to the first baffle plate, the second baffle plate, the third baffle plate, respectively, so that a space enclosed by the first baffle plate, the second baffle plate, the third baffle plate, the fourth baffle plate, and the fifth baffle plate forms the first accommodation slot.

8. The electromagnetic relay according to claim 7, wherein end positions of the first terminal plate, the second terminal plate, the third terminal plate, and the fourth terminal plate disposed outside the casing are provided with at least one open slot.

9. The electromagnetic relay according to claim 5, wherein the second insulation part comprises two sixth baffle plates that are parallel with each other and a seven baffle plate, the seven baffle plate comprises a third bent section, the two sixth baffle plates, respectively, comprise a stepped sheet, with a height difference, having a large-area surface and a small-area surface,
the seven baffle plate is disposed between the two sixth baffle plates, and extends from an end of the large-area surface adjacent to the small-area surface to a diagonally opposite end of the large-area surface,
the small-area surface forms a slot, and
a part of the fourth terminal plate is disposed in the slot.

10. The electromagnetic relay according to claim 9, wherein end positions of the first terminal plate, the second terminal plate, the third terminal plate, and the fourth terminal plate disposed outside the casing are provided with at least one open slot.

11. The electromagnetic relay according to claim 9, wherein a bottom of the second insulation part is provided with a limiting part for abutting and fixing with a mount surface of a working circuit.

12. The electromagnetic relay according to claim 11, wherein end positions of the first terminal plate, the second terminal plate, the third terminal plate, and the fourth terminal plate disposed outside the casing are provided with at least one open slot.

13. The electromagnetic relay according to claim 1, wherein the portions of the first terminal plate, the second terminal plate, the third terminal plate, and the fourth terminal plate disposed outside the casing are arranged in a configuration of one row and four columns.

14. The electromagnetic relay according to claim 13, wherein the casing comprises a third insulation part disposed between the second terminal plate and the third terminal plate, so that the second terminal plate and the third terminal plate are insulated from each other.

15. The electromagnetic relay according to claim 14, wherein the third insulation part comprises a first mount part and a second mount part, the first mount part and the second mount part are relatively isolated area,
the first mount part comprises a first accommodation section and a second accommodation section, the second accommodation section is a downward extension area relative to the first accommodation section, and
the second mount part is disposed under the first accommodation section of the first mount part to form a channel, so that the first mount part is used to accommodate the third terminal plate, and a partial area of the second terminal plate is disposed on the second mount part.
